(19) United States
(12) Patent Application Publication
(10) Pub. No.: US 2005/0225976 A1
(43) Pub. Date: Oct. 13, 2005

(54) Marine LED lighting network and driver

(75) Inventors: Thomas Lawrence Zampini, Morris, CT (US); Thomas Lawrence Zampini II, Morris, CT (US); Mark Alphonse Zampini, Morris, CT (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Integrated Illumination Systems, Inc., Morris, CT (US)

(21) Appl. No.: 11/101,643

(22) Filed: Apr. 8, 2005

Related U.S. Application Data
(60) Provisional application No. 60/560,294, filed on Apr. 8, 2004.

(51) Int. Cl. F21V 9/16

(52) U.S. Cl. 362/227

(57) ABSTRACT

The method and system described herein is designed to illuminate, control, and network LEDs lights used onboard marine platforms. Disclosed is a method and system for illuminating a portion of a marine vessel or platform. A lighting system is controlled by generating a lighting signal for controlling plurality of LED lights placed in a plurality of positions within the vessel. An LED space is designed to illuminate LEDs (or other lighting fixtures) by providing a controller for providing constant current source via a switching regulator configuration.

### RELATED APPLICATIONS

The present application is based on, and claims priority from U.S. Provisional Application No. 60/560,294, filed Apr. 8, 2004, the disclosure of which is hereby incorporated by reference herein in its entirety.

### FIELD OF THE INVENTION

The present invention is directed to a system and method of illuminating an environment and more particularly to an environment such as on a marine vessel. The present invention is also related to an illumination system using LEDs, and a driver having a controller which provides a constant current source to the LEDs.

### BACKGROUND OF THE INVENTION

One of the slowest moving industries in regard to adopting new technologies, the boating industry is years away from being regarded as high tech when compared to automotive and aviation industries. Many traditional systems that were originally specified 30 years ago are still being specified today on brand new vessels. The lighting system has long been plagued by energy inefficiencies, unpredictability, expensive bulb burn-outs, dangerously hot fixture operating temperatures, and simplistic means of control.

The boating industry offers an opportunity that would allow integration of some or all of the light fixtures located on the vessel. At present, the control of lighting zones is restricted as typical controls such as on-off light switches and dimmers are designed to handle current. Therefore, designers are restricted regarding the location of light switches and dimmers as each run of light switches and dimmers would require heavy wire gauge and excessive wiring. Therefore, by providing a networked lighting system, control of fixtures long distances away from the light switch requires no additional wiring and allows the fixture to use a local power source even though the light switch may be 100 feet from the fixture.

The boating industry is also at present adapting the usage of networked based navigational electronics, boat wide local area networks, and integrated displays. Through the integration of this navigational network to the lighting system, provided is the opportunity of using lighting as a means of automated safety. Warnings indicated from the navigation system may be automatically translated into lighting, for example turning on additional exterior lights as another vessel is detected in close proximity by radar.

A need also exists to be able to control the intensity of a lighting system. In any lighting application the act of varying the intensity of lighting fixtures establishes environments for a variety of tasks, whether it is a low light level for a romantic setting or a bright light level for working.

### SUMMARY OF THE INVENTION

Methods and systems are disclosed herein for illuminating marine vessels and platforms, including methods and systems for providing a lighting control signal for controlling a lighting system that has a plurality of LED lights disposed in a plurality of positions within the vessel. An expansion module is for generating a lighting control signal. An interface is provided for the expansion module. One or multiple LED power sources are pos between the expansion module and a plurality of the lights. An LED light is connected to the LED power source that responds to a control signal that is generated by the expansion module and controlled by the user interface.

In embodiments, the LED power source is an electronic module having one of a constant current output or constant voltage output. The LED power source is configured to receive one or multiple analog signals from the expansion module that is configured to set the output of the LED power source.

In one embodiment, the expansion module is configured to provide one or multiple analog signals in the form of pulse width modulation or logic level signals. The expansion module is designed to connect to an analog user interface such as a potentiometer, control voltage, light dimmer, or switch.

In another embodiment, the expansion module also offers a digital user interface and the option of being addressable. Digital user interfaces include a network, computer or microcontroller. The expansion module communicates data with the user interface including at least one of control data, temperature data, operation history data, on-off status data, intensity data, battery condition data, operating time data, power consumption data, error data, color selection data, or system status data.

The expansion module offers integration to networks and will communicate data to a vessel's network wherein the network is at least one of a navigation system, safety system, alarm system, emergency system, weapons system, an entertainment system, or a local area network system.

The expansion module offers integration to computers with at least one of a touch screen, membrane switch, keypad, keyboard, switch, mouse, or dimmer as a user interface. Through graphical user interfaces, graphical representations of lighting zones may be used for simple addressing and control of expansion modules.

Marine environments wherein the environment is at least one of commercial, military, or recreational, including pleasure craft are suitable for the described system. Optional interfaces include interfaces to the marine vessel's local area network, navigational network, safety network, alarm network, emergency network, weapons network, or entertainment network.

The expansion module offers control of a plurality of LED lights to adjust at least one of the intensity, the on/off, or the color of the light fixture.

Methods and systems are provided herein for controlling a plurality of lights to provide illumination of one or multiple colors, one of the colors being white light. White light may be generated by a white LED source or through the combination of red, green, and blue LED light sources. The LED light sources can be a LED light source such as a red source, amber source, red-orange source, green source, blue source, cyan source, yellow source, orange source, royal-blue source, or UV source, generally LEDs of any color or combination of colors. White LEDs may be of one or more color temperatures.

Methods and systems provided herein provide illumination control over a single zone to the complete vessel. The system allows analog or digital control of one of multiple expansion modules. Each expansion module constitutes a zone. The expansion module is designed to send an analog PWM signal to one or many LED power sources over short or long distances. The signal is generated within the expansion module via a microprocessor. This signal is designed to set the output of one or multiple LED power sources, thus the expansion module when combined with the LED Driver creates a dimming system. The expansion module is not connected to the input of the LED power source where current is handled, rather the expansion module simply provides a signal to reference. The expansion module offers the option of one or multiple control signals to perform operations such as changing colors. The expansion module also offers monitoring of the environment of which it and the LED fixtures are installed, including temperature data and battery condition data.

The LED power sources are designed to provide constant current or constant voltage to the light sources as described herein. The LED power source receives the analog input from the Expansion Module. This analog PWM signal is averaged by the LED power source and translated into a reference voltage. The LED power source may be located internally or externally of the LED Light Source's Fixture. The LED Power source may drive one or multiple LED Light Sources. It is important to note that the LED current on an elementary level, is close to proportional to the LED intensity.

In different embodiments, a secondary system is provided for adjusting the light output of the light system. This is done through the use of at least one of an optic, lens, reflector, filter, gel, diffuser, mirror, or reflective coating. A means of integrating the secondary system to the LED light is through the use of a fixture wherein the LED light source and the secondary system are located within the same fixture. This fixture may be installed within the vessel located in at least one of the helm, bridge, mast, cockpit, tower, bow, stern, gunnels, bridge, rode locker, hull, swim platform, baitwell, fishbox, salon, stateroom, galley, head, shower, closet, storage space, engine room, crews quarters, companionway, bunk room, training room, weapons room, or control room.

In embodiments, the LED light may be installed for purposes of general illumination, courtesy illumination, indirect illumination, ambient lighting, navigational illumination, or emergency illumination. For general illumination applications, the LED light may be installed overhead.

Still other aspects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and in several details are capable of modifications in various obvious respects, all without departing from the invention. Accordingly, the drawings are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a block diagram illustrating an expansion module, LED power source, and LED fixture configured with an analog user interface;

FIG. 2 is a block diagram illustrating an expansion module, LED power source, and LED fixture configured with a digital input;

FIG. 3 is a block diagram illustrating an expansion module, LED power source, and LED fixture configured with digital input and network connection;

FIG. 4 is an illustration of an expandable lighting network; and

FIG. 5 is a circuit of a LED driver module.

### BEST MODE FOR CARRYING OUT THE INVENTION

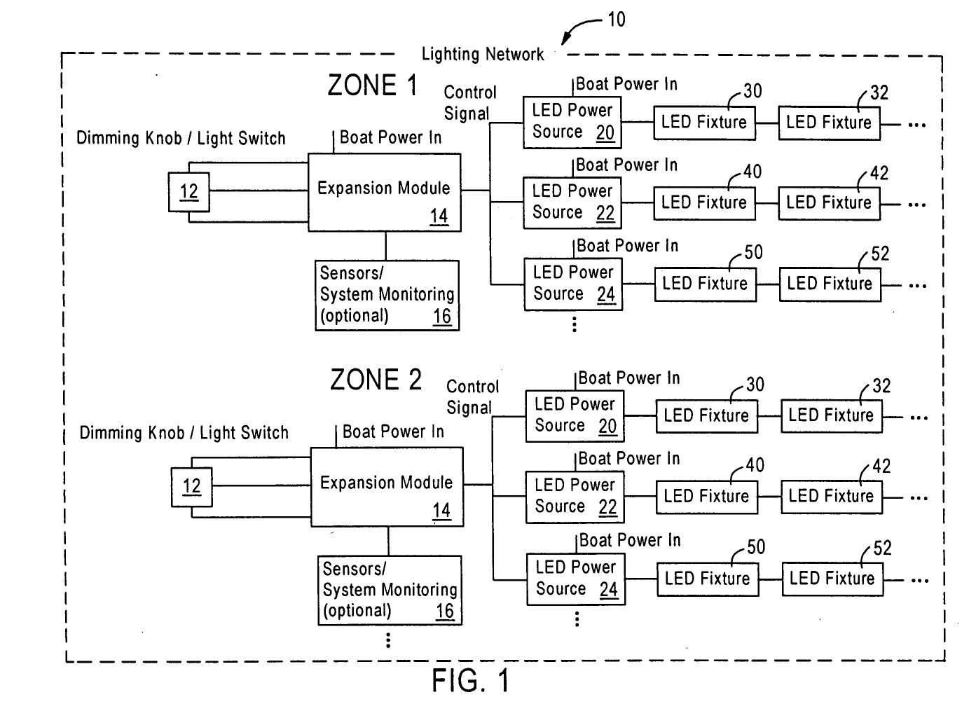

A lighting network is depicted in FIG. 1 having zones 1 and 2. As depicted in FIG. 1, Zone 2 has the identical configuration of zone 1, although this is for illustrative purposes only. The present invention can combine the embodiments depicted in FIGS. 1-3. Also, the FIG. 1 embodiment, for example, can use other LED power sources.

In FIG. 1, a conventional Light Switch/Dimming Knob 12 is used to control an expansion module 14. This may be done a number of ways including utilizing a control voltage that the expansion module 14 references. Optional sensor system monitoring 16 is connected to the expansion module 14 for monitoring the expansion module's 14 environment. The expansion module 14 generates a control signal that controls the output of each of the LED power sources 20, 22, 24. Each LED power source 20, 22, 24 provides a constant output to each LED fixtures 30, 40, 50 to which it supplies power. The number of LED power sources is not limited to three. Each power source 20, 22, 24 has two LED fixtures associated therewith 30, 32 and 40, 42 and 50, 52 respectively. Each power sources 20, 22, 24 receives electric power independently from an external power source. The number of LED fixtures is not limited to two per expansion module. Multiple expansion modules 14 may be used to create zones of LED fixtures, similar to lighting zones found today. For example, zone 1 may be the galley of the vessel, zone 2 may be the master stateroom.

The power supplies 20, 22, 24 can be the LED driver 404 (described later) or can be any type of power supply (i.e. linear).

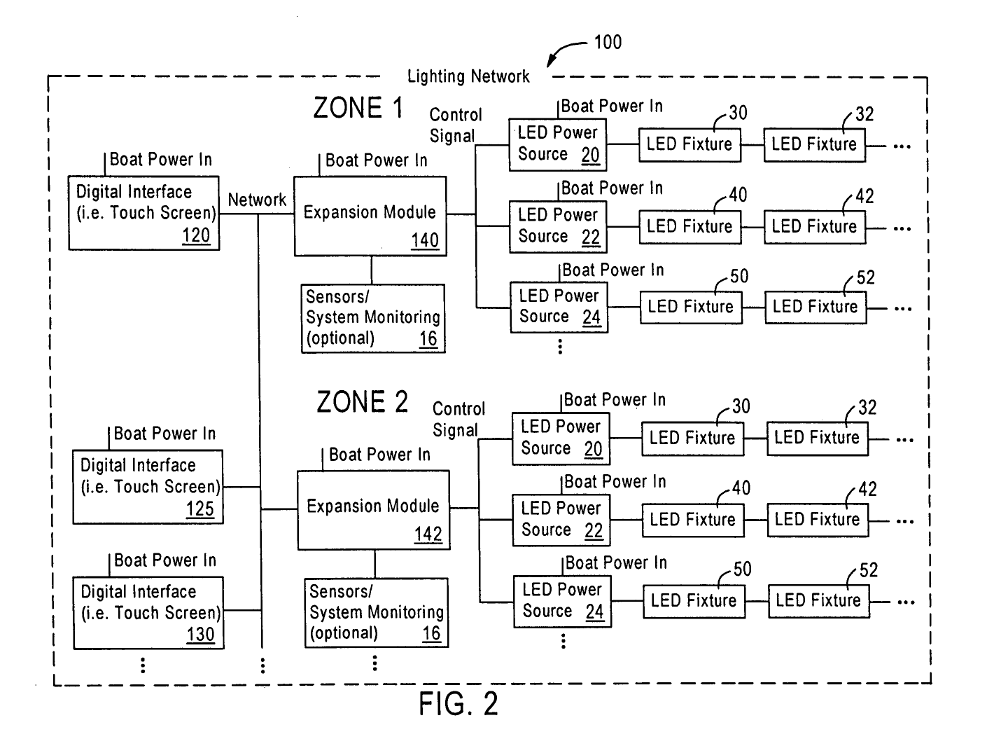

In FIG. 2 is an illustration of lighting network 100. As opposed to connecting an analog user interface directly to the expansion module 14; each expansion module 140, 142 is configured to received a digital user interface 120, 125, 130, in this case being a network. The network is configured such that there are multiple expansion modules located on it and the zones may be controlled by one or multiple digital interfaces located throughout the vessel (i.e. one on the helm, one in the master stateroom, etc.). The 120, 125, 130 digital interface can be as advanced as a touch screen with a series of menus for selecting expansion modules; however the digital interface can be as simple as a digital microcontroller with a switch or potentiometer connected to it to control on/off or adjust brightness. Regardless, both methods have a digital element and a digital signal being sent to 1 or multiple expansion modules. Other than the change in interface, FIG. 2 is the same as FIG. 1.

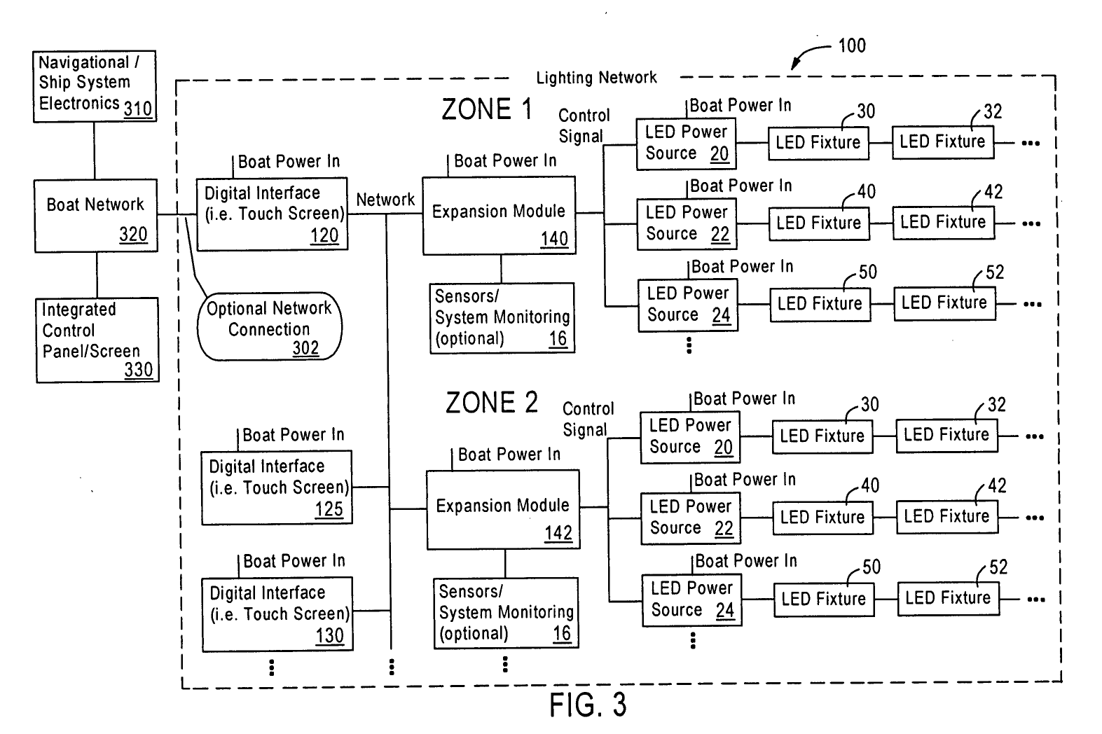

FIG. 3 is the same as FIG. 2 with the exception that the lighting network 100 is also connected to an outside network using an optional network connection 302, one of which may be a navigational ship systems electronics or navigational network 310, a boat or local area network 320 or integrated central panel screen 330. Through this network interface 302, the lighting network 100 may be linked to other pieces of equipment located onboard the vessel and controlled through existing user interfaces. This configuration also offers the ability to use the lighting network 100 as a means of connecting to equipment that may provide warning or safety data to the lighting network 100, thus allowing the lighting network 100 to perform intelligent tasks based on these signals. For example, when the vessel is drifting or anchored, the radar is set on alert, which is a typical function that specifies a specific range to monitor. If any object is picked up on radar, such as another boat, within the specified area, the radar will notify the captain with a warning signal, such as an audible beep. Typically, this radar display is not within the living areas of the vessel, which offers a very limited range of who can hear this warning.

Integration to the lighting network answers this problem. By integrating the lighting network into the radar's network, the lighting network can be programmed by the user to turn on and control specific lights on the vessel, interior and exterior. For example, the system may be programmed to turn on the lights in the captain's stateroom to alert of the warning, or it may be programmed to turn on additional external lights, thus alerting the other vessel of your presence.

The use of colored light may also be applied. For example, in the captain's stateroom example as described above, the captain's stateroom may illuminate with red light in case of an emergency. The man overboard feature on many of today's electronics may be integrated into the lighting network such that upon pressing man overboard button, the lighting network will display on the exterior lighting a preprogrammed color and flash rate to indicate the condition, for example, an amber light flashing at 0.5 second intervals.

The lighting network may also be configured to strobe or flash the lights on the network. For example, if the lighting network receives a signal from the vessel's network indicating an emergency condition, the exterior lighting will flash “SOS” in Morse Code to alert other vessels, including both marine and aerial, that may come to aid of the vessel.

The lighting network may also be configured to integrate to the engine monitoring/control network. Today, most engines are controlled and monitored electronically. By interfacing to this network, the lighting network 100 will offer the ability to aid the captain in servicing the vessel as well as provide illumination under special conditions. For example, if the engine monitoring system provides a signal that one of the engines has overheated, the lighting network 100 may automatically turn on the expansion modules located in the engine room, thus the LED fixtures such that the captain does not need be concerned with finding the right light switch, rather can focus on the problem at hand.

Another area where any lighting networks 10, 100 excels is in navigational lighting safety. For example, by integrating a photocell device to the lighting network as well as the engine monitoring/control network, at any point that the vessel is in gear (forward or reverse) and the surrounding light level around the vessel is low enough that it is of the legal requirement for navigational running lights, the lighting network will automatically illuminate the navigational running lights on the vessel. Should the same vessel later that evening drop anchor, by integrating the lighting network into the anchor windlass and radar, the lighting networks 10, 100 will change the navigational running light configuration to the anchor light configuration and will set the radar on watch as described above.

For large vessels where entering and exiting a port requires procedural lighting sequencing, the lighting networks 10, 100 simplify the tasks for the crew by automating the required sequences. These sequences may be preprogrammed such that LED fixtures will illuminate for example at timed intervals or based on some outside influence.

At other times, the captain may prefer to illuminate the entire exterior of the vessel when entering port. With the lighting networks 10, 100, this may be done at the push of a single button. The expansion modules 14, 140, 142 may also be configured to power on the LED power sources 20-24 at a strategic sequence to reduce the potential power spike associated with turning on many electrical devices simultaneously. Likewise, with the push of a single button, the captain may shut off all exterior illumination.

The lighting networks 10, 100 may be configured to offer users of the vessel their personal presets. Through the user interface 120, 125, 130, a user may select their preset configuration to control the environment of the vessel to their preference. This may consist of preferred light levels, light color, light sequencing, and activated LED Fixtures. For example, the vessel owner may prefer a soothing illumination effect as the vessel is a place of refuge, whereas the owner's teenage child may prefer bright, colorful, and sequenced illumination with the perception that the vessel is a place of entertainment. In addition, through integration of the lighting network to an entertainment system on the vessel, vessel illumination may be coordinated with multimedia.

By integrating the lighting network to the Local Area Network on a vessel, the vessel's illumination may be controlled by a PC locally on the vessel or from a remote location. For example, one may control the interior illumination of their vessel from their home 1,000 miles from their vessel in order to simulate that the vessel is in use. Other examples include the scenario where one may monitor their vessel remotely by CCTV. In this case, as CCTV does not perform optimally in low light levels, remote access of the vessel's illumination would provide a means of illuminating the vessel for surveillance purposes.

The expansion modules 140, 142 communicate data with the interface 120 including at least one of control data, temperature data, operation history data, on-off status data, intensity data, battery condition data, operating time data, power consumption data, error data, color selection data, or system status data. The expansion modules 140, 142 communicate data to the vessel's network wherein the network is at least one of a navigation system, safety system, alarm system, emergency system, weapons system, entertainment system, or local area network system. The expansion modules 140, 142 communicates data to a computer with at least one of a touch screen, membrane switch, keypad, keyboard, switch, mouse, dimmer or potentiometer as a user interface.

An LED driver 404 is designed to illuminate LEDs (or other lighting fixtures) by providing a constant current source via a switching regulator configuration. A constant current source allows any type or number of LEDs within a specified range, to be connected to the driver. The driver will automatically adjust the output voltage to maintain a preset constant current output. This type of regulator is standard practice for constant current and has been used in the battery charger industry for a number of years.

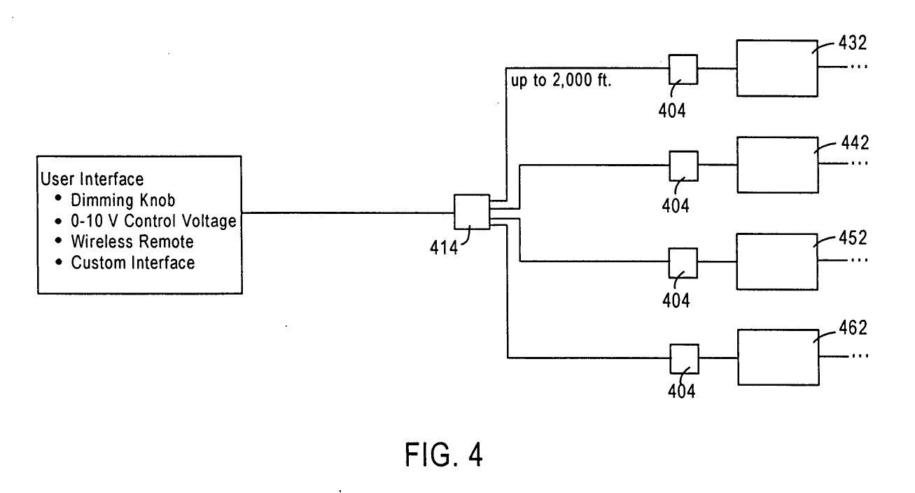

As depicted in FIG. 4 four LED drivers 404 are positioned between an expansion module 414 and lighting fixture 432, 442, 452, 462 so that there is one LED driver 404 per lighting fixture 432, 442, 452, 462. The LED controller 404 provides a means of controlling the current using an expansion module 414 which includes a digital microcontroller and the LED driver 404 which receives an analog signal from the FIG. 6 is a functional diagram microcontroller.

The expansion module 414 is designed to send an analog signal to many LED drivers 404 over long distances although a digital signal can also be used. While this signal is created by a digital control, the signal is clearly analog as is the user interface. The expansion module 414 is controlled via a potentiometer, a 0 to 10 VDC control voltage, a wireless remote control (RF or IR) etc. These analog inputs linearly tell the microcontroller what PWM duty cycle to produce (i.e. 20-%). This analog signal (the PWM generated waveform) is received by the LED controllers 404.

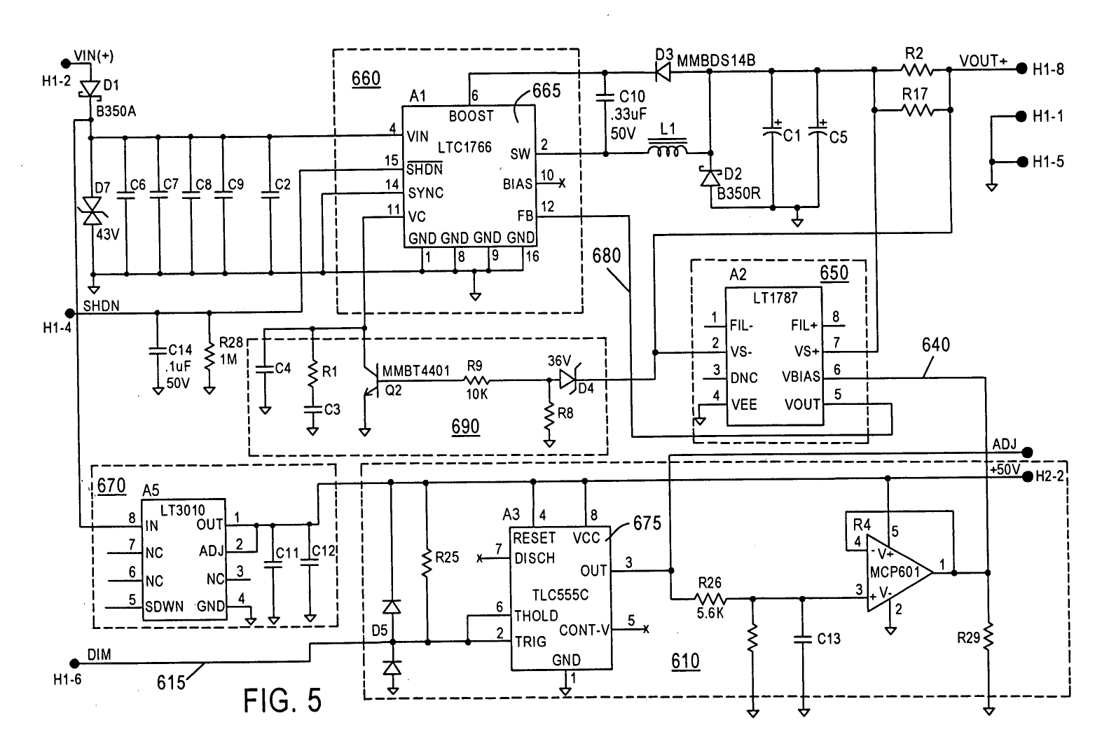

The LED drivers 404 via analog methods, interpret the incoming waveform and set the brightness of the LEDs. When wired in series, the brightness of each of the LEDs is the same. The brightness is set by averaging the PWM signal and then creating a DC voltage that controls an opamp through the opamp's v-bias pin. The opamp controls a reference voltage that connects to the switching regulator. This reference voltage tells the regulator to reduce the output voltage, thus reducing the current. The LEDs will dim down from full brightness to zero output or vice versa and everything in between. Note that the LEDs are not pulse width modulated, PWM, flashed to control brightness, rather the current is adjusted. So an LED at 500 mA is 50% as bright at 1000 mA constant current. The LED drivers never receive digital signals with address information, nor do they receive a digital signal to set the output current. A circuit diagram of the LED drivers 404 is shown in FIG. 5.

As can be seen in FIG. 5, the LED controller 404 includes a PMW signal 615 averaging circuit 610, a switching regulator 660, a current sense amplifier 650, and a dedicated linear regulator 670. The LED controller 404 utilizes a common ground throughout its circuitry as best seen at pins H1-8, H1-1, and H1-5 in FIG. 5. The PMW signal averaging circuit 610 is coupled to receive the PMW analog signal 615, at pin H1-6, from the expansion module 414 (FIG. 4), then averages the received PMW analog signal 615 to obtain a DC voltage 640 The DC voltage 640 is fed to the V-bias pin of the current sense amplifier 650, which, in response to the DC voltage 640, outputs a reference voltage 680. The reference voltage 680 is supplied to the switching regulator 660 to reduce or increase the output voltage, thus reducing or increasing the output current.

In the preferred embodiment illustrated in FIG. 5, the LED controller 404 utilizes a step-down topology, e.g., with Vin (at pin H1-2)=Vout (at pin H1-8)+3. Accordingly, the switching regulators 660 also is a step-down switching regulators. The specific embodiment depicted in FIG. 5 uses a switching regulator 660 (for example model No. LT1766 available from Linear Technology Milpitas, Calif.) and a current sense amplifier 650 (for example model No. LT1787) for sensing current and providing a feedback path to the switching regulator 660. The integration of the current sense amplifier 650 to this circuit promotes highly efficient operation. However, other configurations using different types of switching regulator are not excluded.

The linear regulator 670 utilizes a low current high voltage linear regulator, e.g., a micropower regulator. However, other configurations using different types of power supply are within the scope of the present invention. Alternatively, the dedicated power supply 670 may be omitted. The linear regulator 670 is used to power the averaging circuitry 610.

A timing IC, e.g., is used as the timing component of the PMW signal averaging circuit 610. Again, the present invention is not limited to the specifically disclosed configuration. The LED controller 404 may also include various components such as filtering capacitors, surge protection circuitry and switching transistor.

The integration of circuit 690 allows for open circuit protection such that if Vout (H1-8) is disconnected while power is applied to the LED driver 404 the switching regulator 660 will not be damaged.

The marine LED lighting network system allows the user to dim one or multiple LED fixtures such that this environment selection may be achieved. The LED driver 404 also provides the advantage of accepting a wide range of input voltages. This allows the input voltage to vary without affecting the intensity of the fixtures. For example, if the lighting system is connected to a 24 VDC battery source located on board the vessel, typically, when the battery charger activates, the voltage to the lighting system can go as high as 28 VDC. Traditional light sources, such as halogens, under this condition would increase in intensity while simultaneously decrease in longevity due to the fact that the bulbs typically are rated for 24 VDC. The LED driver 404 solves this by offering a wide range of input voltages. Regardless of whether the voltage is 20, 24, or 28 VDC, the LED driver 404 will provide the same constant output to the LED fixture. The LED fixture will never experience an over-current/over-voltage condition should the LED driver 404 be operated within its maximum and minimum ratings.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A method of illuminating a portion of a marine vessel or platform, comprising the steps of:
controlling a lighting system that has a plurality of LED lights placed in a plurality of positions within the vessel by generating a lighting control signal.

2. The method of claim 1, further comprising one or multiple LED power sources between an expansion module and the plurality of the LED lights.

3. The method of claim 1, further comprising interfacing to a human being to control the lighting system.

4. The method of claim 1, further comprising a lighting system interfacing to sensor on the marine vessel.

5. The method of claim 1, wherein the LED power source is an electronic assembly having one of a constant current output or constant voltage output.

6. The method of claim 2, wherein the expansion module is configured to generate a control signal to set the output of the LED power source.

7. The method of claim 3, wherein the interface is an analog user interface.

8. The method of claim 3, wherein the interface is a digital user interface.

9. The method of claim 8, wherein said digital interface is one of an RS-485 interface, an RS-232 interface, can bus, lin bus, and an ethernet interface.

10. The method of claim 8, wherein the user interface is at least one of a network, computer, or microcontroller.

11. The method of claim 8, wherein the expansion module is addressable.

12. The method of claim 8, wherein the expansion module communicates data with the interface including at least one of control data, temperature data, operation history data, on-off status data, intensity data, battery condition data, operating time data, power consumption data, error data, color selection data, or system status data.

13. The method of claim 8, wherein the expansion module communicates data to the vessel's network wherein the network is at least one of a navigation system, safety system, alarm system, emergency system, weapons system, entertainment system, or local area network system.

14. The method of claim 8, wherein the interface is at least one of a touch screen interface, touch pad interface, membrane switch interface, keypad interface, keyboard interface, switch interface, mouse interface, conventional lighting interface, wireless interface, network interface, computer interface, dimmer interface, or potentiometer interface as a user interface.

15. The method of claim 8, wherein the digital user interface is built in to the expansion module.

16. The method of claim 8, wherein the expansion module communicates with the navigational network to provide navigational alerts observed by the navigational equipment.

17. The method of claim 10, wherein the computer uses a graphical touch screen to display lighting zones that may be selected and controlled.

18. The method of claim 4, wherein the user interface is one of a potentiometer, control voltage, light dimmer, or switch.

19. The method of claim 1, wherein the expansion module provides an analog control signal to the LED power source.

20. The method of claim 1, wherein the expansion module provides at least 1 output that connects to the LED power source.

21. The method of claim 1, wherein the application is a marine environment.

22. The method of claim 21, wherein the application is at least one of a commercial, military, or recreational marine vessel or vessel platform, including pleasure craft.

23. The method of claim 21, further comprising an interface to the vessel's network.

24. The method of claim 1, wherein the application has a plurality of lighting zones, wherein the light systems illuminate areas of the vessel including exterior and interior lighting applications.

25. The method of claim 1 wherein there is a local power source at each expansion module and LED power source.

26. The method of claim 1, further comprising controlling a plurality of LED lights using the expansion module to adjust at least one of the intensity, the on/off, or the color of the light; wherein one available color of light is white light.

27. The method of claim 26, wherein white light is generated by a white LED light source.

28. The method of claim 26, wherein white light is generated by combination of red, green, and blue LED light sources.

29. The method of claim 26, further comprising a second LED light source.

30. The method of claim 29, wherein the second LED light source is generated by a red source, amber source, red-orange source, green source, blue source, cyan source, yellow source, orange source, royal-blue source, or UV source.

31. The method of claim 26, wherein the LEDs are driven and controlled by a constant current source.

32. The method of claim 26, wherein the LEDs are dimmed by adjusting the LED current.

33. The method of claim 26, wherein the LEDs are dimmed by pulse-width modulation, a method of flashing to control brightness.

34. The method of claim 26, further comprising providing a secondary system for adjusting the light output of the light system.

35. The method of claim 34, wherein the secondary system is at least one of an optic, lens, reflector, filter, gel, diffuser, mirror, or a reflective coating.

36. The method of claim 26, wherein the LED light source and secondary system is located within a fixture.

37. The method of claim 36, wherein the fixture is installed within the vessel.

38. The method of claim 1, wherein the LED light is located in at least one of the helm, bridge, mast, cockpit, tower, bow, hull, stern, gunnels, bridge, rode locker, swim platform, baitwell, fishbox, salon, stateroom, galley, head, shower, closet, storage space, engine room, crews quarters, companionway, bunk room, training room, weapons room, or control room.

39. The method of claim 1, wherein the LED light is used for general illumination.

40. The method of claim 39, wherein the LED light is installed overhead.

41. The method of claim 1, wherein the LED light is used for courtesy illumination.

42. The method of claim 1, wherein the LED light is used for indirect lighting.

43. The method of claim 1, wherein the LED light is used for navigational lighting.

44. The method of claim 1, wherein the LED light is used for emergency lighting.

45. The method of claim 1, wherein the LED light is used for signaling.

46. The method of claim 14, wherein the wireless facility is one of 802.11, Bluetooth, or Radio Frequency (RF).

47. The method of claim 1 wherein the interface is an interface for a conventional lighting system.

48. A lighting system, comprising:
a plurality of LEDS;
an LED power source connected to the plurality of LEDs;
an interface to accept input from one of a user or a sensor;
an expansion module connected between the interface and the LED power source for generating a control signal for controlling the LEDs.

49. The system of claim 48, wherein the interface is at least one of a wire, a cable, a network, a bus, a circuit, or a wireless interface.

50. The system of claim 48, wherein the LED power source is an electronic assembly having one of a constant current output or constant voltage output.

51. The system of claim 48, further comprising one or multiple LED power sources between an expansion module and the plurality of the LED lights.

52. The system of claim 51, wherein the expansion module is configured to generate a control signal to set the output of the LED power source.

53. The system of claim 48, wherein the interface is an analog user interface.

54. The system of claim 48, wherein the interface is a digital user interface.

55. The system of claim 54, wherein the user interface is at least one of a network, computer, or microcontroller.

56. The system of claim 55, wherein the expansion module is addressable.

57. The system of claim 54, wherein the expansion module communicates data with the interface including at least one of control data, temperature data, operation history data, on-off status data, intensity data, battery condition data, operating time data, power consumption data, error data, color selection data, or system status data.

58. The system of claim 52, wherein the expansion module communicates data to the vessel's network wherein the network is at least one of a navigation system, safety system, alarm system, emergency system, weapons system, entertainment system, or local area network system.

59. The system of claim 52, wherein the interface is at least one of a touch screen interface, touch pad interface, membrane switch interface, keypad interface, keyboard interface, switch interface, mouse interface, conventional lighting interface, wireless interface, network interface, computer interface, dimmer interface, or potentiometer interface as a user interface.

60. The system of claim 52, wherein the digital user interface is built in to the expansion module.

61. The system of claim 54, wherein the expansion module communicates with the navigational network to provide navigational alerts observed by the navigational equipment.

62. The system of claim 57, wherein the computer uses a graphical touch screen to display lighting zones that may be selected and controlled.

63. The system of claim 48, wherein the interface is a user interface which is one of a potentiometer, control voltage, dimmer or switch.

64. The system of claim 48, wherein the expansion module provides an analog control signal to the LED power source.

65. The system of claim 48, wherein the expansion module provide at least 1 digital output that connects to the LED power source.

66. The system of claim 48, wherein said lighting system has a plurality of lighting zones, wherein the light systems illuminate areas of the vessel including exterior and interior lighting applications.

67. The system of claim 48, wherein there is a local power source at each expansion module and LED power source.

68. The system of claim 48, further comprising controlling a plurality of LED lights using the expansion module to adjust at least one of the intensity, the on/off, or the color of the light; wherein one available color of light is white light.

69. The system of claim 68, wherein white light is generated by a white LED light source.

70. The system of claim 68, wherein white light is generated by combination of red, green, and blue LED light sources.

71. The system of claim 70, further comprising a second LED light source.

72. The system of claim 71, wherein the second LED light source is generated by a red source, amber source, red-orange source, green source, blue source, cyan source, yellow source, orange source, royal-blue source, or UV source.

73. The system of claim 68, wherein the LEDs are driven and controlled by a constant current source.

74. The system of claim 68, further comprising providing a secondary system for adjusting the light output of the light system.

75. The system of claim 74, wherein the secondary system is at least one of an optic, lens, reflector, filter, gel, diffuser, mirror, or a reflective coating.

76. The system of claim 68, wherein the LED light source and secondary system is located within a fixture.

77. The system of claim 76, wherein the fixture is installed within the vessel.

78. The system of claim 48, wherein the LED light is located in at least one of the helm, bridge, mast, cockpit, tower, bow, hull, stern, gunnels, bridge, rode locker, swim platform, baitwell, fishbox, salon, stateroom, galley, head, shower, closet, storage space, engine room, crews quarters, companionway, bunk room, training room, weapons room, or control room.

79. A lighting system, comprising:
at least one lightning fixture; at least one device for providing constant current to said at least one lighting fixture;
an expansion module which sends a control signal to the at least one driver; and
a user interface.

80. The lighting system of claim 79, wherein said at least one lighting fixture is an LED.

81. The lighting system of claim 79, wherein said expansion module includes a digital microcontroller.

82. The lighting system of claim 79, wherein the control signal sent from the expansion module is an analog signal.

83. The lighting system of claim 79, wherein the user interface is one of a potentiometer, a 0-10 VDC control voltage, a wireless remote and a digital interface.
